(19) United States
(12) Patent Application Publication
(10) Pub. No.: US 2014/0057077 A1
(43) Pub. Date: Feb. 27, 2014

(54) EXTRUSION MOLDING DEVICE, MOLDED ARTICLE, AND METHOD OF PRODUCING THE SAME

(71) Applicant: Sony Corporation, Tokyo (JP)

(72) Inventors: Hiroyasu Sato, Tokyo (JP); Takuya Toriumi, Kanagawa (JP); Takeo Mitsui, Kanagawa (JP)

(73) Assignee: Sony Corporation, Tokyo (JP)

(21) Appl. No.: 13/965,464

(22) Filed: Aug. 13, 2013

(30) Foreign Application Priority Data
Aug. 24, 2012 (JP) 2012-185692

(51) Int. Cl. B29C 47/00

(52) U.S. Cl. CPC B29C 47/0061
USPC 428/141; 264/210.1; 425/377

(57) ABSTRACT

An extrusion molding device includes: an extrusion die configured to extrude a molten material; a sizing die configured to shape the material extruded by the extrusion die; and a transfer device configured to follow the material and to be operated, the material passing through the sizing die, and configured to transfer a transfer surface formed as a specular surface to the material.

### BACKGROUND

The present technology relates to a technological field of an extrusion molding device, a molded article, and a method of producing the molded article. Particularly, the present disclosure relates to a technological field in which a transfer device which follows a material and is operated, the material passing through a sizing die, and which transfers a transfer surface to the material in a contact manner to form a glossy surface with reduced manufacturing cost.

Electronic devices include various types of devices, for example, a television receiver, a personal computer, a mobile phone, a mobile terminal device, a disk drive device, and an acoustic device, and each of these electronic devices includes various types of necessary components.

Some of those various types of components are components (molded articles), each of which is formed by an extrusion molding device which has, for example, an extrusion die and a sizing die. In the extrusion molding device, a molten material is extruded by an extrusion die, the material extruded by the extrusion die is shaped by a sizing die, and is subsequently cooled, thereby forming a molded article (for example, see Japanese Unexamined Patent Application Publication No. 10-272669).

A component formed by such an extrusion molding device is typically a molded article formed in a shape extending in one direction, and such a molded article includes, for example, each side of a frame-shaped bezel which is provided in a display device such as a television receiver.

### SUMMARY

The above-mentioned molded article such as a bezel is visually recognized from the outside, and thus, in some cases, the surface thereof is formed as a glossy surface so as to improve the design.

In related art, such a glossy surface is formed by an extrusion molding device, for example, in the following manner: when a material passes through a sizing die, a film having a glossy surface is applied to a surface of the material, and after the molded article is formed, the applied film is peeled off.

The gloss of the film is transferred to the molded article, and the surface of the molded article, where the film is peeled off, is formed as a glossy surface.

However, in the above-described method of forming a glossy surface on a molded article using a film, the step of peeling off the film is necessary after the formation of the molded article, and thus manufacturing time as well as manufacturing cost is increased accordingly.

In addition, the cost of materials increases because a film is necessary, and the peeled off film is discarded and not reused, and consequently the manufacturing cost is further increased.

Thus, it is desirable to form a glossy surface with reduced manufacturing cost by an extrusion molding device, a molded article, and a method of producing the molded article of the present technology.

First, according to an embodiment of the present technology, there is provided an extrusion molding device including: an extrusion die configured to extrude a molten material; a sizing die configured to shape the material extruded by the extrusion die; and a transfer device configured to follow the material and to be operated, the material passing through the sizing die, and configured to transfer a transfer surface formed as a specular surface to the material.

Consequently, in the extrusion molding device, the transfer surface of the transfer device is transferred to the material, thereby forming a glossy surface on the molded article.

Second, it is desirable that a transfer roller be used as the transfer device in the extrusion molding device, the transfer roller following the material and being rotated.

A transfer roller, which follows the material and is rotated, is used as the transfer device, thereby transferring a specular surface geometry to the molded article as the transfer roller rotates.

Third, it is desirable that a plurality of the transfer rollers be disposed apart in the moving direction of the material which has been extruded and moved.

A plurality of the transfer rollers are disposed apart in the moving direction of the material which has been extruded and moved, thereby transferring respective specular surface geometries of the transfer surfaces to the material multiple times.

Fourth, it is desirable that a transfer belt be used as the transfer device in the extrusion molding device, the transfer belt following the material and being moved.

A transfer belt, which follows the material and is moved, is used as the transfer device, thereby transferring a specular surface geometry to the molded article as the transfer belt moves.

Fifth, it is desirable that the extrusion molding device be provided with a temperature controller configured to adjust the temperature of the surface of the transfer device.

The extrusion molding device is provided with a temperature controller configured to adjust the temperature of the surface of the transfer device, thereby performing transfer from the transfer surface to the material in a heated condition.

According to an embodiment of the present technology, there is provided a molded article which is formed in such a manner that a transfer device follows a material and is operated, the material passing through a sizing die for shaping a molten material extruded by an extrusion die, and a surface of the transfer device is transferred to the material, the surface being formed as a specular transfer surface.

Consequently, the transfer surface of the transfer device is transferred to the material, thereby forming a glossy surface on the molded article.

According to an embodiment of the present technology, there is provided a method of producing a molded article, the method including: extruding a molten material by an extrusion die; shaping the material by a sizing die, the material being extruded by the extrusion die; and transferring a surface of a transfer device to the material, the surface being formed as a specular transfer surface, the transfer device following the material and being operated, the material passing through the sizing die.

Consequently, the transfer surface of the transfer device is transferred to the material, thereby forming a glossy surface on a molded article by the method of producing a molded article.

An extrusion molding device according to an embodiment of the present technology includes: an extrusion die configured to extrude a molten material; a sizing die configured to shape the material extruded by the extrusion die; and a transfer device configured to follow the material and to be operated, the material passing through the sizing die, and configured to transfer a transfer surface formed as a specular surface to the material.

Consequently, at the same time when the material passes through the sizing die to be shaped, the specular surface geometry of the transfer surface of the transfer device is transferred to the material so as to form a glossy surface on the molded article, and thus a glossy surface can be formed on the molded article with reduced manufacturing cost.

According to an embodiment of the present technology, a transfer roller is used as the transfer device in the extrusion molding device, the transfer roller following the material and being rotated.

Consequently, a specular surface geometry is transferred to the molded article with a simple configuration, and a glossy surface can be formed on the molded article with the simple configuration maintained.

According to an embodiment of the present technology, a plurality of the transfer rollers are disposed apart in the moving direction of the material which has been extruded and moved.

Consequently, respective specular surface geometries of the transfer surfaces are transferred to the material multiple times, and thus high transfer performance to the molded article can be assured.

According to an embodiment of the present technology, a transfer belt is used as the transfer device, the transfer belt following the material and being moved.

Consequently, a specular surface geometry is transferred to the molded article with a simple configuration, and a glossy surface can be formed on the molded article with the simple configuration maintained.

According to an embodiment of the present technology, the extrusion molding device is provided with a temperature controller configured to adjust the temperature of the surface of the transfer device.

Consequently, transfer from the transfer surface to the material is performed in a heated condition, and improvement in accuracy of the transfer to the molded article can be achieved.

A molded article according to an embodiment of the present technology is formed in such a manner that a transfer device follows a material and is operated, the material passing through a sizing die for shaping a molten material extruded by an extrusion die, and a surface of the transfer device is transferred to the material, the surface being formed as a specular transfer surface.

Consequently, at the same time when the material passes through the sizing die to be shaped, the specular surface geometry of the transfer surface of the transfer device is transferred to the material so as to form a glossy surface on the molded article, and thus a glossy surface can be formed on the molded article with reduced manufacturing cost.

A method of producing a molded article according to an embodiment of the present technology includes: extruding a molten material by an extrusion die; shaping the material by a sizing die, the material being extruded by the extrusion die; and transferring a surface of a transfer device to the material, the surface being formed as a specular transfer surface, the transfer device following the material and being operated, the material passing through the sizing die.

Consequently, at the same time when the material passes through the sizing die to be shaped, the specular surface geometry of the transfer surface of the transfer device is transferred to the material so as to form a glossy surface on the molded article, and thus a glossy surface can be formed on the molded article with reduced manufacturing cost.

### BRIEF DESCRIPTION OF THE DRAWINGS

FIG. 1 together with FIGS. 2 to 5 illustrates an embodiment of the present technology, and FIG. 1 is a schematic diagram of an extrusion molding device;

FIG. 2 is a front view of a sizing die;

FIG. 3 is a perspective view of the sizing die;

FIG. 4 is a perspective view illustrating a sizing die having a transfer device according to a first modification; and

FIG. 5 is a perspective view illustrating a sizing die having a transfer device according to a second modification.

### DETAILED DESCRIPTION OF EMBODIMENTS

Hereinafter, a preferred embodiment for achieving an extrusion molding device, a molded article, and a method of producing a molded article of the present technology will be described with reference to the accompanying drawings.

In the preferred embodiment illustrated below, the extrusion molding device of the present technology serves as a device which molds a member as a molded article, the member constituting a bezel of a television receiver having a flat display panel, the molded article of the present technology serves as the member which constitutes the bezel of the television receiver, and the method of producing the molded article of the present technology serves as a method of molding the member which constitutes the bezel.

It is to be noted that application range of the extrusion molding device, the molded article, and the method of producing the molded article of the present technology is not limited to the device which molds the member as a molded article, the member constituting the bezel of a television receiver having a flat display panel, the member which constitutes the bezel of the television receiver, and the method of molding the member which constitutes the bezel.

The application range of the extrusion molding device may be wide enough to include various types of extrusion molding devices which mold various types of molded articles.

The application range of the molded article and the method of producing the molded article of the present technology may be wide enough to include the various types of molded articles formed by the extrusion molding device and the method of molding the various types of molded articles.

### [Configuration of Extrusion Molding Device]

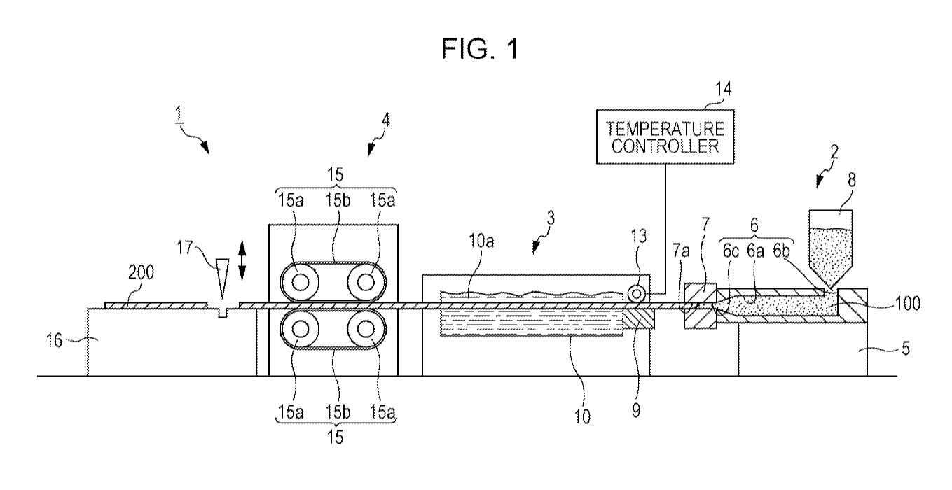

An extrusion molding device 1 includes an extrusion unit 2, a shaping unit 3, and a transport unit 4 (see FIG. 1).

The extrusion unit 2 has a base 5, a flow unit 6 disposed on the base 5, an extrusion die 7 connected to the flow unit 6, and a supply unit 8 for supplying a material 100 to the flow unit 6.

In the flow unit 6, a flow passage 6a, through which the material (molten material) 100 flows, is formed. One end of the flow passage 6a is formed as an inlet port 6b, and the other end of the flow passage 6a is formed as a supply port 6c.

The extrusion die 7 has a molding passage 7a internally, and the material 100 is formed in a certain shape by the molding passage 7a. One end of the molding passage 7a communicates with the supply port 6c of the flow unit 6.

The supply unit 8 has a function of supplying the material 100 to the flow unit 6, and the material 100 is supplied to the flow unit 6 from the supply unit 8 via the inlet port 6b.

The shaping unit 3 has a sizing die 9 and a cooling pool 10.

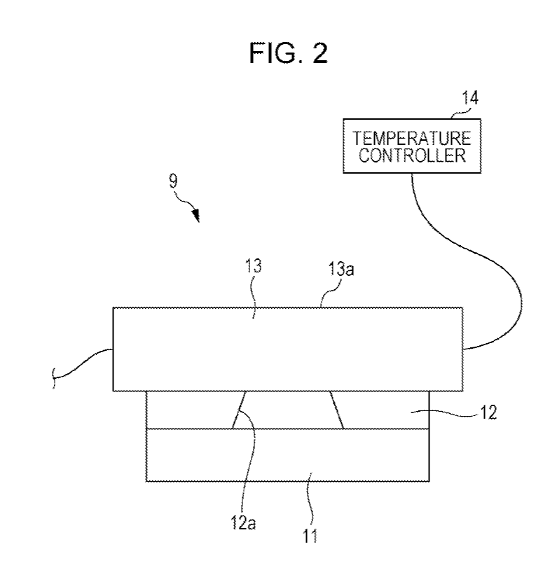

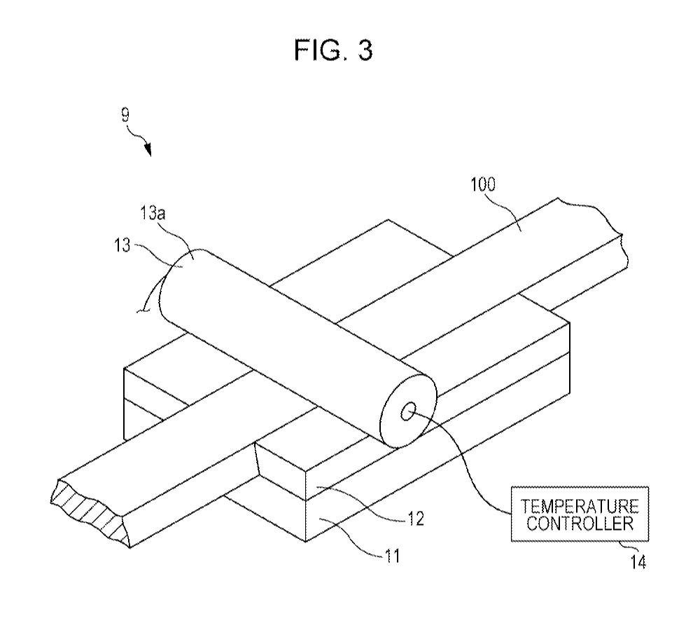

The sizing die 9 has a function of shaping the material 100 which is extruded from the extrusion die 7, and includes a base die 11, a shaping die 12 disposed on the base die 11, and a transfer roller 13 which rotates on the shaping die 12 and serves as a transfer device (see FIGS. 2 and 3).

The base die 11 is formed in a plate shape.

In the shaping die 12, a shaping passage 12a is formed which is open upward, toward the position where the material 100 passes through.

The rotational axis of the transfer roller 13 has a direction perpendicular to the moving direction of the material 100. The surface of the transfer roller 13 is formed as a transfer surface 13a which is a specular surface, and the transfer roller 13 is in contact with the upper surface of the shaping die 12 with the shaping passage 12a being straddled by the transfer surface 13a. Consequently, when the transfer roller 13 rotates, the transfer surface 13a slides on the upper surface of the shaping die 12.

A temperature controller 14 is connected to the transfer roller 13. The temperature of the transfer surface 13a of the transfer roller 13 is adjusted by the temperature controller 14.

A cooling fluid 10a such as cooling water is stored in the cooling pool 10 in which the material 100, which has passed through the sizing die 9, is cooled (see FIG. 1).

In the transport unit 4, a pair of vertically-spaced transport devices 15, 15 are disposed. The transport device 15 is formed such that a transport belt 15b is stretched between rollers 15a and 15a, for example.

A working table 16 is disposed on the side of the transport unit 4 that is opposite to the shaping unit 3. A cutter 17 is vertically movably disposed above the working table 16.

### [Method of Producing Molded Article by Extrusion Molding Device]

Hereinafter, a method of producing a molded article by an extrusion molding device 1 is illustrated (see FIG. 1).

First, the material 100 (molten material 100) 100 is supplied to the flow unit 6 from the supply unit 8 via the inlet port 6b.

The material 100 supplied to the flow unit 6 is flown through the flow passage 6a, is supplied to the molding passage 7a of the extrusion die 7 through the supply port 6c, and is extruded by the extrusion die 7 to be formed in a certain shape.

The material 100 extruded by the extrusion die 7 is supplied to the sizing die 9, and is moved through the shaping passage 12a of the sizing die 9 to be shaped. In the above process, the transfer roller 13 rotates, and the temperature controller 14 applies heat to the transfer surface 13a of the transfer roller 13 so as to control the transfer surface 13a at a predetermined temperature.

The transfer roller 13 follows the material 100 and is rotated at a speed according to the speed of the material 100 which is moved through the shaping passage 12a. In the above process, the specular surface geometry of the transfer surface 13a is transferred to the material 100, so that the surface of the material 100 is formed to be a glossy surface.

The material 100, which has been shaped by the sizing die 9 and for which the glossy surface has been formed by the transfer roller 13, is subsequently cooled and solidified by the cooling pool 10.

The material 100, which has been cooled by the cooling pool 10, is inserted between the transport devices 15, 15, and is transported to the working table 16 by the transport devices 15, 15. When the material 100 is transported to the working table 16, the cutter 17 moves down to cut the material 100 to a predetermined length. The cutter 17, after cutting the material 100, moves up, and the material 100 cut by the cutter 17 is formed as a molded article 200 which is a member constituting a bezel.

As described above, in the extrusion molding device 1, the transfer roller 13, which follows the material 100 and is rotated, is used as a transfer device, and thus the specular surface geometry is transferred to the molded article 200 with a simple configuration, and a glossy surface can be formed on the molded article 200 with the simple configuration maintained.

The extrusion molding device 1 is provided with the temperature controller 14 for adjusting the temperature of the transfer surface 13a of the transfer roller 13, and thus transfer from the transfer surface 13a to the material 100 is performed in a heated condition, and improvement in accuracy of the transfer to the molded article 200 can be achieved.

### [Modification of Transfer Device]

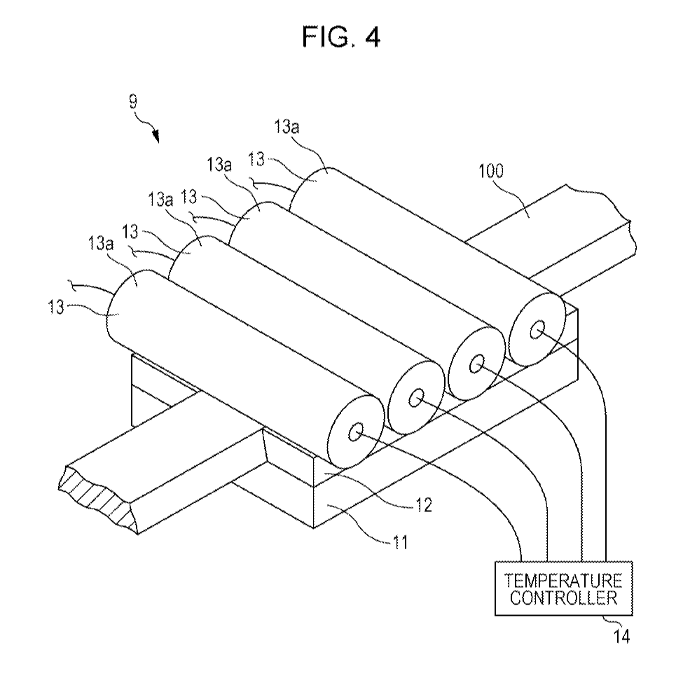

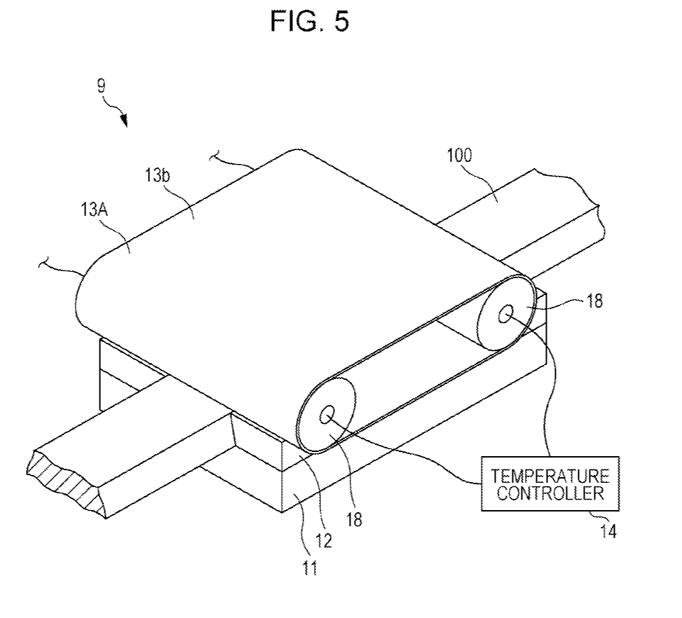

Hereinafter, a modification of the transfer device will be described (see FIGS. 4 and 5).

### [First Modification]

A transfer device according to a first modification includes a plurality of transfer rollers 13, 13, . . . which are disposed side by side in the moving direction of the material 100. Any of the directions of the rotational axes of the transfer rollers 13, 13, . . . is perpendicular to the moving direction of the material 100. The surface of each transfer roller 13 is formed as a transfer surface 13a which is a specular surface, and the transfer roller 13 is in contact with the upper surface of the shaping die 12 with the shaping passage 12a being straddled by the transfer surface 13a. Consequently, when the transfer roller 13 rotates, the transfer surface 13a slides on the upper surface of the shaping die 12.

The temperature controller 14 is connected to the transfer rollers 13, 13, . . . The temperature of each of the transfer surfaces 13a, 13a, . . . of the transfer rollers 13, 13, . . . is adjusted by the temperature controller 14.

When the material 100 extruded by the extrusion die 7 is supplied to the sizing die 9 in the extrusion molding device 1 which uses the transfer rollers 13, 13, . . . , the transfer rollers 13, 13, . . . follow the material 100 and are rotated, the material 100 being moved through the shaping passage 12a to be shaped. In the above process, the temperature controller 14 applies heat to the transfer surfaces 13a, 13a, . . . of the transfer rollers 13, 13, . . . so as to control the transfer surfaces 13a, 13a, . . . at a predetermined temperature.

The transfer rollers 13, 13, . . . follow the material 100 and are rotated, and thus respective specular surface geometries of the transfer surfaces 13a, 13a, . . . are transferred to the material 100, so that the surface of the material 100 is formed to be a glossy surface.

In this manner, the respective specular surface geometries of the transfer surfaces 13a, 13a, . . . are transferred to the material 100 multiple times by using a plurality of transfer rollers 13, 13, . . . as transfer devices, and thus high transfer performance to the molded article 200 can be assured.

### [Second Modification]

A transfer device according to a second modification includes a transfer belt 13A. The transfer belt 13A is wound and stretched between driving rollers 18, 18 which are disposed apart in the moving direction of the material 100. Any of the directions of the rotational axes of the driving rollers 18 is perpendicular to the moving direction of the material 100. The surface of the transfer belt 13A is formed as a transfer surface 13b which is a specular surface, and the transfer belt 13A is in contact with the upper surface of the shaping die 12 with the shaping passage 12a being straddled by the transfer surface 13b. Consequently, when the transfer belt 13A is moved, the transfer surface 13b slides on the upper surface of the shaping die 12.

The temperature controller 14 is connected to the transfer belt 13A. The temperature of the transfer surface 13b of the transfer belt 13A is adjusted by the temperature controller 14.

When the material 100 extruded by the extrusion die 7 is supplied to the sizing die 9 in the extrusion molding device 1 which uses the transfer belt 13A, the transfer belt 13A follows the material 100 and is moved, the material 100 being moved through the shaping passage 12a to be shaped. In the above process, the temperature controller 14 applies heat to the transfer surface 13b of the transfer belt 13A so as to control the transfer surface 13b at a predetermined temperature.

The transfer belt 13A follows the material 100 and is moved, and thus the specular surface geometry of the transfer surface 13b is transferred to the material 100, so that the surface of the material 100 is formed to be a glossy surface.

In this manner, the transfer belt 13A is used as a transfer device, and thus the specular surface geometry is transferred to the molded article 200 with a simple configuration, and a glossy surface can be formed on the molded article 200 with the simple configuration maintained.

### [Conclusion]

As described above, the extrusion molding device 1 includes the extrusion die 7 which extrudes the material 100, the sizing die 9 which shapes the material 100 extruded by the extrusion die 7, the transfer roller 13 or the transfer belt 13A which follows the material 100 and is operated, the material 100 passing through the sizing die 9, and which transfers the transfer surfaces 13a, 13b each formed as a specular surface to the material 100.

Consequently, at the same time when the material 100 passes through the sizing die 9 to be shaped, the respective specular surface geometries of the transfer surfaces 13a,13b of the transfer roller 13 or the transfer belt 13A are transferred to the material 100 so as to form a glossy surface on the molded article 200. Therefore, there is no need to form a glossy surface on the molded article 200 using a film having a glossy surface as in related art, and thus a glossy surface can be formed on the molded article 200 with reduced manufacturing cost.

### [Present Technology]

The present technology may have the following configuration.

(1) An extrusion molding device including:

an extrusion die configured to extrude a molten material;

a sizing die configured to shape the material extruded by the extrusion die; and

a transfer device configured to follow the material and to be operated, the material passing through the sizing die, and configured to transfer a transfer surface formed as a specular surface to the material.

(2) The extrusion molding device according to statement (1), in which a transfer roller is used as the transfer device, the transfer roller following the material and being rotated.

(3) The extrusion molding device according to statement (2), in which a plurality of the transfer rollers are disposed apart in the moving direction of the material which has been extruded and moved.

(4) The extrusion molding device according to statement (1), in which a transfer belt is used as the transfer device, the transfer belt following the material and being moved.

(5) The extrusion molding device according to any one of statements (1) to (4), further including a temperature controller configured to adjust the temperature of the surface of the transfer device.

(6) A molded article which is formed in such a manner that a transfer device follows a material and is operated, the material passing through a sizing die for shaping a molten material extruded by an extrusion die, and a surface of the transfer device is transferred to the material, the surface being formed as a specular transfer surface.

(7) A method of producing a molded article, the method including:

extruding a molten material by an extrusion die;

shaping the material by a sizing die, the material being extruded by the extrusion die; and

transferring a surface of a transfer device to the material, the surface being formed as a specular transfer surface, the transfer device following the material and being operated, the material passing through the sizing die.

Specific shape and structure of each component illustrated in the preferred embodiment for implementing the above-described technology is just an example of implementation of the present technology, and the technical scope of the present technology should not be construed in any limited sense by the specific shape and structure.

The present disclosure contains subject matter related to that disclosed in Japanese Priority Patent Application JP 2012-185692 filed in the Japan Patent Office on Aug. 24, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An extrusion molding device comprising:
an extrusion die configured to extrude a molten material;
a sizing die configured to shape the material extruded by the extrusion die; and
a transfer device configured to follow the material and to be operated, the material passing through the sizing die, and configured to transfer a transfer surface formed as a specular surface to the material.

2. The extrusion molding device according to claim 1,
wherein a transfer roller is used as the transfer device, the transfer roller following the material and being rotated.

3. The extrusion molding device according to claim 2,
wherein a plurality of the transfer rollers are disposed apart in a moving direction of the material which has been extruded and moved.

4. The extrusion molding device according to claim 1,
wherein a transfer belt is used as the transfer device, the transfer belt following the material and being moved.

5. The extrusion molding device according to claim 1, further comprising a temperature controller configured to adjust a temperature of a surface of the transfer device.

6. A molded article which is formed in such a manner,
wherein a transfer device follows a material and is operated, the material passing through a sizing die for shaping a molten material extruded by an extrusion die, and a surface of the transfer device is transferred to the material, the surface being formed as a specular transfer surface.

7. A method of producing a molded article, the method including:
extruding a molten material by an extrusion die;
shaping the material by a sizing die, the material being extruded by the extrusion die; and
transferring a surface of a transfer device to the material, the surface being formed as a specular transfer surface, the transfer device following the material and being operated, the material passing through the sizing die.
